(19) United States
(12) Patent Application Publication
(10) Pub. No.: US 2026/0084462 A1
(43) Pub. Date: Mar. 26, 2026

(54) BICYCLE WHEEL ASSEMBLY STRUCTURE

(71) Applicant: HEXA CO., LTD., Taipei City (TW)

(72) Inventor: Mark CHEN, Taipei City (TW)

(21) Appl. No.: 19/406,859

(22) Filed: Dec. 2, 2025

Related U.S. Application Data
(63) Continuation-in-part of application No. 18/107,511, filed on Feb. 9, 2023, now abandoned.

(51) Int. Cl. B60B 1/04

(52) U.S. Cl. CPC B60B 1/045; B60B 1/041; B60B 1/042

(57) ABSTRACT

A bicycle wheel assembly structure includes an annular rim, a hub, nipples, and spokes. The annular rim includes multiple rim penetration sections, each of which includes a rim-side limiting part on a circumference. The hub is arranged at the center of the annular rim. The hub includes multiple hub penetration sections. The rim-side limiting part and the nipple limiting part, and also the hub-side limiting part and the spoke limiting part, are all made in a hexagonal pyramid form with apex truncated to form a planar surface and including bevel facets so as to provide an anti-sliding effect resulting from geometric constraint and high static friction at both the annular rim-side and the hub-side. The angle of the hexagonal pyramid of the nipple limiting part is 60°, 90°, or 120°, and an optimum arrangement can be made based on the material elongation of the spokes and the desired tension.

### CROSS REFERENCE TO RELATED APPLICATIONS

This is a continuation-in-part of co-pending US Patent Application Serial No. 18/107,511 filed on February 9, 2023.

### BACKGROUND OF THE INVENTION

### TECHNICAL FIELD OF THE INVENTION

The present invention relates to innovation in bicycle wheel assembly structure, and more particularly to a bicycle wheel assembly structure featuring multi-angle geometric constraint, anti-loosening structure, and operability based on material selection, which can improve the shock resistance, versatility, and anti-sliding effect of the wheel assembly.

### DESCRIPTION OF THE PRIOR ART

The common industry practice for preventing bicycle spokes from loosening involves increasing resistance between the external thread of the spoke and the internal thread of the nipple to reduce relative sliding between the spoke and the nipple.

It is often that a nylon insert is added between the spoke and the nipple to resist sliding, or an adhesive is applied to secure the spoke and the nipple, or the shapes of the external thread of the spoke and the internal thread of the nipple are modified to prevent loosening.

However, the deficiency caused by such known solutions is that a nylon insert has only a limited effect of resisting sliding, and requires additional materials and the cost for applying. Securing with adhesive would make it impossible for subsequent fine adjustment. Modifying the shapes of the external thread of the spoke and the internal thread of the nipple may result in difficulty of assembling and may not meet the specification requirements.

### SUMMARY OF THE INVENTION

An objective of the present invention is to provide a bicycle wheel assembly structure, which allows selection of a geometric angle based on the material elongation and the state of use of spokes.

Another objective of the present invention to achieve a long-term anti-loosening effect through double-end geometric locking between a rim-side limiting part and a nipple limiting part, and between a hub-side limiting part and a spoke limiting part.

A further objective of the present invention is to reduce assembly resistance and stress concentration through an innovative design with truncated apex and bevel facets, thereby improving shock resistance and versatility.

A further objective of the present invention is to achieve convenient maintenance and quick adjustment, with a long-term stable tension control effect.

### BRIEF DESCRIPTION OF THE DRAWINGS

FIG. 1 is a side elevational view showing arrangement of nipples and spokes according to an embodiment of the present invention.

FIG. 2 is a side elevational view showing arrangement of nipples and spokes according to another embodiment of the present invention.

FIG. 3 is a schematic view showing a state of use of the present invention.

FIG. 4A is a side elevational view showing a nipple limiting part in the form of a convex hexagonal pyramid having an apex angle of 60° according to the present invention.

FIG. 4B is an end view of FIG. 4A.

FIG. 5A is a side elevational view showing a nipple limiting part in the form of a cone having an apex angle of 60° according to the present invention.

FIG. 5B is an end view of FIG. 5A.

FIG. 6A is a side elevational view showing a nipple limiting part in the form of a convex hexagonal pyramid having an apex angle of 90° according to the present invention.

FIG. 6B is an end view of FIG. 6A.

FIG. 7A is a side elevational view showing a nipple limiting part in the form of a cone having an apex angle of 90° according to the present invention.

FIG. 7B is an end view of FIG. 7A.

FIG. 8A is a side elevational view showing a nipple limiting part in the form of a convex hexagonal pyramid having an apex angle of 120° according to the present invention.

FIG. 8B is an end view of FIG. 8A.

FIG. 9A is a side elevational view showing a nipple limiting part in the form of a cone having an apex angle of 120° according to the present invention.

FIG. 9B is an end view of FIG. 9A.

FIG. 10A is a side elevational view showing a nipple according to the present invention.

FIG. 10B is an end view of FIG. 10A.

FIG. 11A is a side elevational view showing a nipple and a washer according to an embodiment of the present invention.

FIG. 11B is an end view of FIG. 11A.

### DETAILED DESCRIPTION OF THE PREFERRED EMBODIMENTS

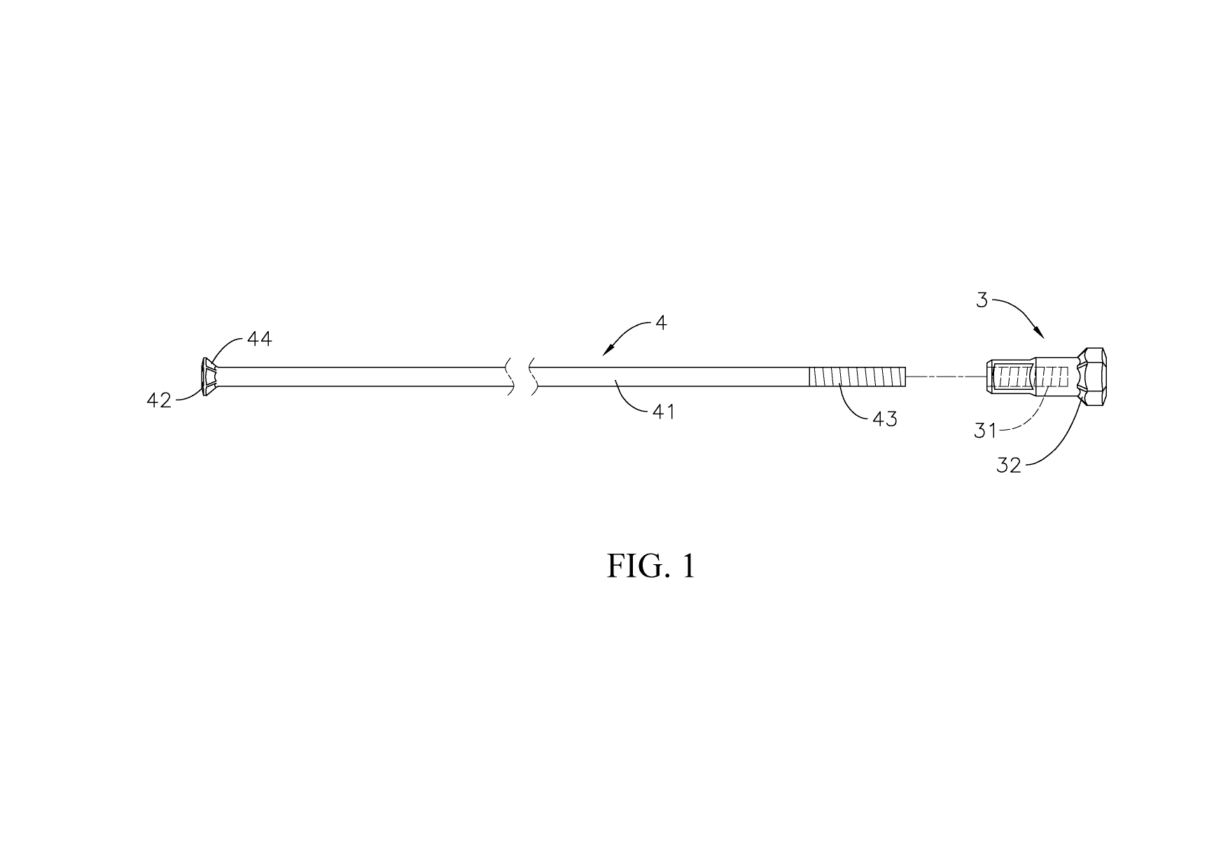

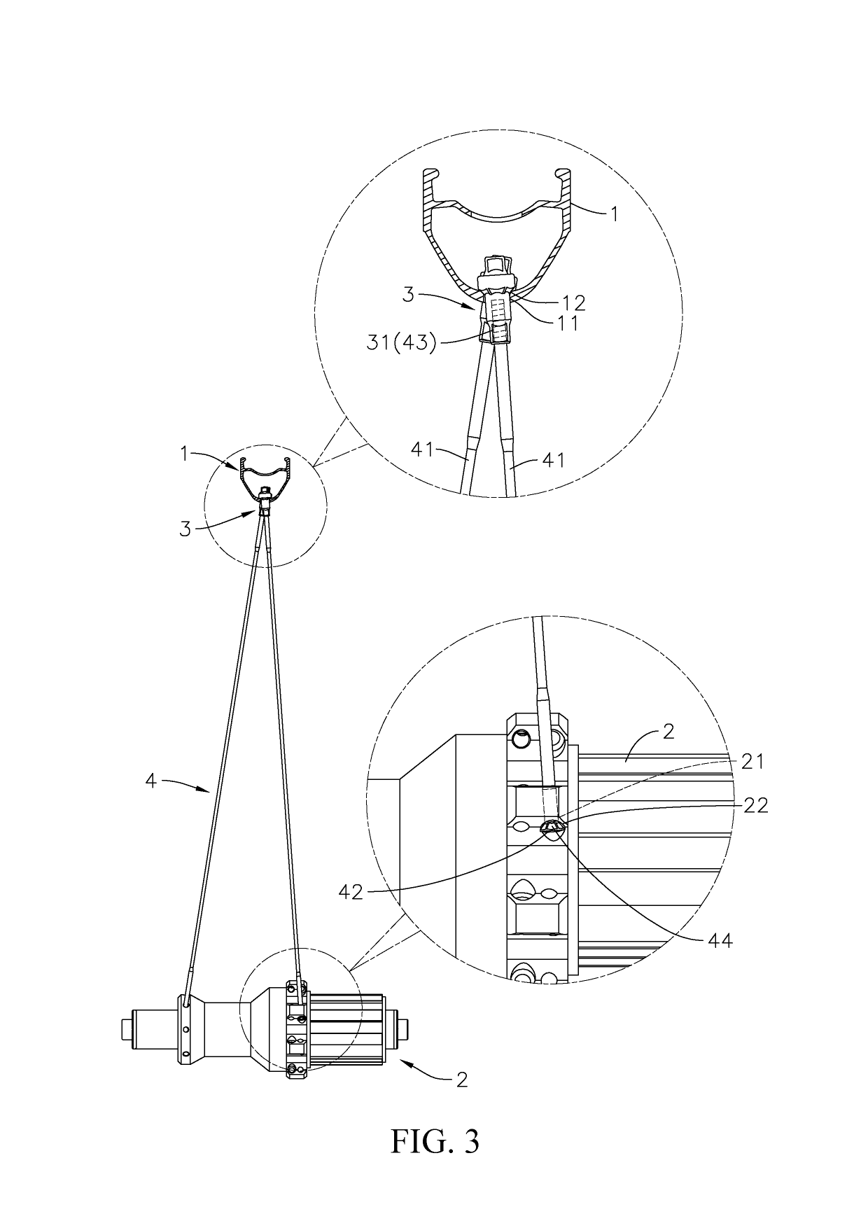

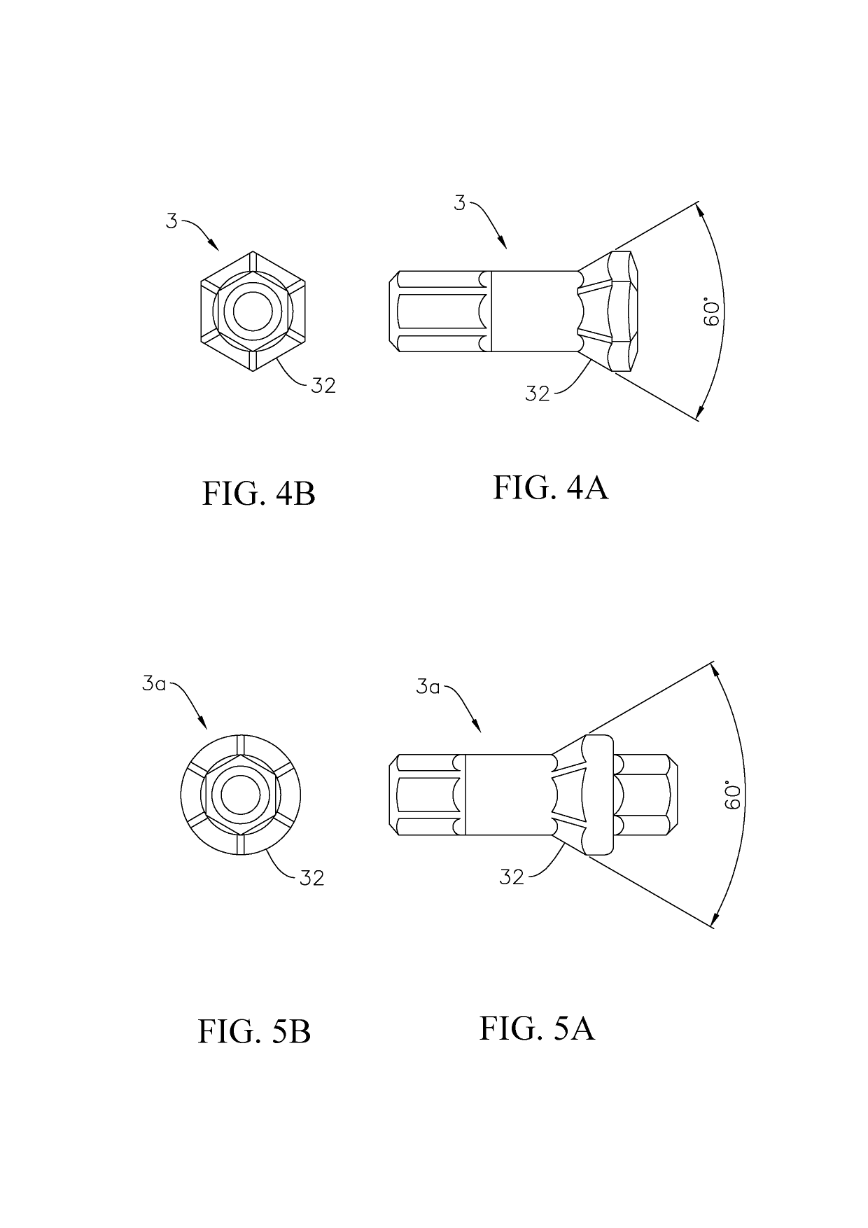

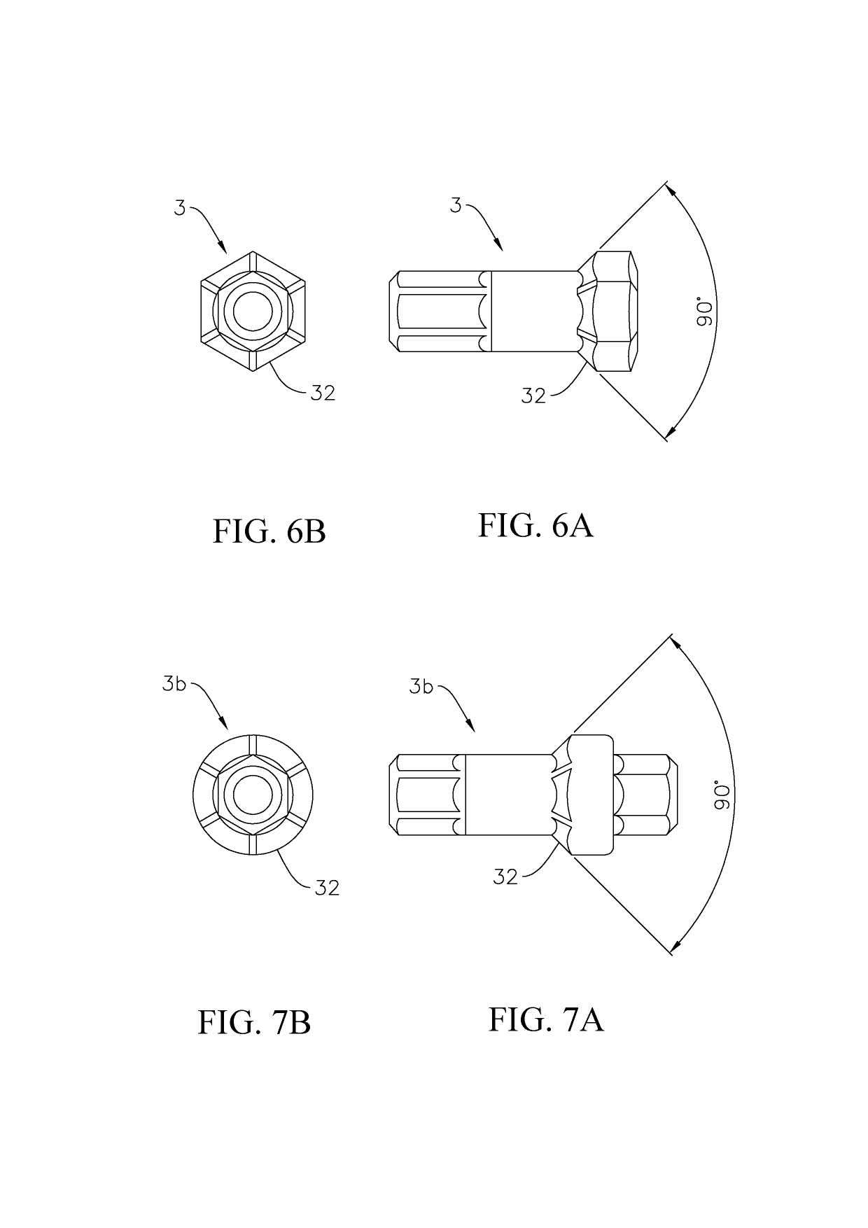

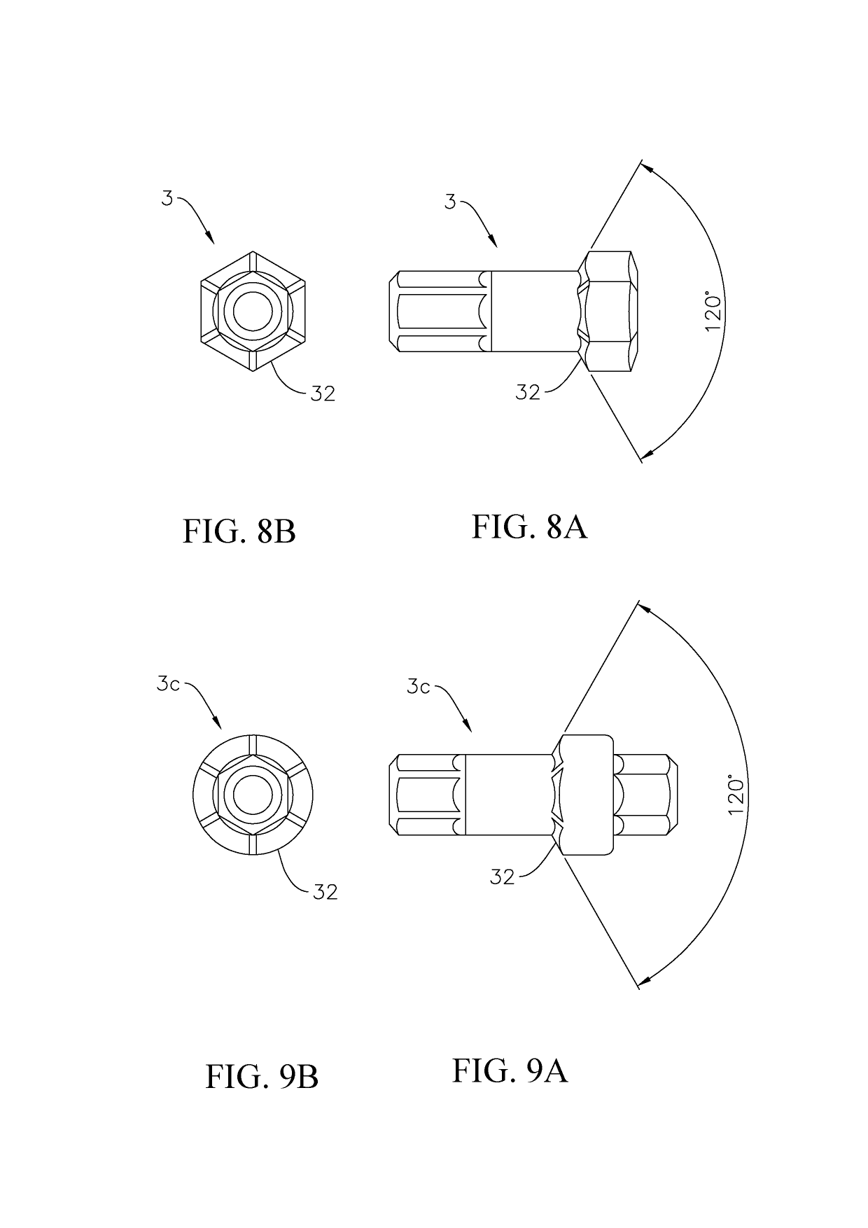

Reference is now made to FIGS. 1-9B, which are respectively a side elevational view showing arrangement of nipples and spokes according to an embodiment of the present invention; a side elevational view showing arrangement of nipples and spokes according to another embodiment of the present invention; a schematic view showing a state of use of the present invention; a side elevational view showing a nipple limiting part in the form of a convex hexagonal pyramid having an apex angle of 60° according to the present invention; an end view of FIG. 4A; a side elevational view showing a nipple limiting part in the form of a cone having an apex angle of 60° according to the present invention; an end view of FIG. 5A; a side elevational view showing a nipple limiting part in the form of a convex hexagonal pyramid having an apex angle of 90° according to the present invention; an end view of FIG. 6A; a side elevational view showing a nipple limiting part in the form of a cone having an apex angle of 90° according to the present invention; an end view of FIG. 7A; a side elevational view showing a nipple limiting part in the form of a convex hexagonal pyramid having an apex angle of 120° according to the present invention; an end view of FIG. 8A; a side elevational view showing a nipple limiting part in the form of a cone having an apex angle of 120° according to the present invention; and an end view of FIG. 9A.

As shown in FIGS. 1-3, 4A and 4B, 6A and 6B, and 8A and 8B, the present invention discloses a bicycle wheel assembly structure, which at least comprises an annular rim 1, a hub 2, multiple nipples 3, and multiple spokes 4.

The annular rim 1 is provided with multiple rim penetration sections 11, and each of the rim penetration sections 11 is provided, on a circumference thereof, with a rim-side limiting part 12.

The hub 2 is arranged at the center of the annular rim 1, and the hub 2 is provided with multiple hub penetration sections 21.

Each of the nipples 3 is provided, in the inside thereof, with a thread-connecting section 31, and each of the nipples 3 is provided, on the outside thereof, with a nipple limiting part 32. The nipples 3 are respectively arranged on the rim penetration sections 11 of the annular rim 1, and the nipple limiting part 32 of each of the nipples 3 is mounted to a respective one of the rim-side limiting parts 12.

Each of the spokes 4 comprises an intermediate section 41, a head section 42, and a thread section 43. The head section 42 is arranged at one end of the intermediate section 41, and the thread section 43 is arranged at an opposite end of the intermediate section 41. The head sections 42 of the spokes 4 are respectively mounted to the hub penetration sections 21, and the thread sections 43 of the spokes 4 are respectively mounted to the thread-connecting sections 31 of the nipples 3.

Each rim-side limiting part 12 is in the form of a concave hexagonal pyramid cavity with an apex truncated to form a planar surface, and each rim-side limiting part 12 has an inside surface in the form of a polygonal surface including bevel facets. Each nipple limiting part 32 is in the form of a convex hexagonal pyramid with an apex truncated to form a planar surface and including bevel facets. Thus, the nipple limiting part 32 and the rim-side limiting part 12 match each other and are combinable with each other, so as to constrain each other in position once combined.

Each of the hub penetration sections 21 is provided, on an inside circumference thereof, with a hub-side limiting part 22. Each of the spokes 4 is provided, on an outside circumference of the head section 42, with a spoke limiting part 44. The head sections 42 of the spokes 4 are mounted to the hub penetration sections 21 by means of the spoke limiting parts 44 respectively.

Each hub-side limiting part 22 is in the form of a concave hexagonal pyramid cavity with an apex truncated to form a planar surface, and each hub-side limiting part 22 has an inside surface in the form of a polygonal surface including bevel facets. Each spoke limiting part 44 is in the form of a convex hexagonal pyramid with an apex truncated to form a planar surface and including bevel facets. Thus, the spoke limiting part 44 and the hub-side limiting part 22 match each other and are combinable with each other, so as to constrain each other in position once combined.

The thread sections 43 of the spokes 4 are respectively connected to the thread-connecting sections 31 of the nipples 3, and are screwed tightly to induce a tension, which drives the nipple limiting parts 32 to deeply penetrate into the respective rim-side limiting parts 12, making tight contact with and abutting against the polygonal surface to form interference fitting therebetween so as to generate a high static frictional force.

Simultaneously, the spoke limiting part 44 on the opposite end of each of the spokes 4 is put through the respective one of the hub-side limiting parts 22, and geometric constraint is similarly achieved through contact with the polygonal surface. Thus, an effect of geometric friction-induced sliding prevention and positioning is simultaneously generated on two opposite sides respectively associated with the annular rim 1 and the hub 2, and loosening or rotational shifting caused by vibration can be avoided.

The convex hexagonal pyramid of each nipple limiting part 32 has an apex angle that can be one of 60°, 90°, and 120°, and this is selected and set according to elongation of the material of each respective spoke 4.

In one embodiment of the bicycle wheel assembly structure, the apex angle of the convex hexagonal pyramid of the nipple limiting part 32 is 60° for use with a material of high elongation.

In one embodiment of the bicycle wheel assembly structure, the apex angle of the convex hexagonal pyramid of the nipple limiting part 32 is 90° for use with a material of medium elongation.

In one embodiment of the bicycle wheel assembly structure, the apex angle of the convex hexagonal pyramid of the nipple limiting part 32 is 120° for use with a material of low elongation.

In one embodiment of the bicycle wheel assembly structure, the contact surfaces of the rim-side limiting part 12 and the nipple limiting part 32 may include a rough patter or a minute toothed pattern to increase the static frictional force.

In one embodiment of the bicycle wheel assembly structure, the intermediate section 41, the head section 42, and the thread section 43 of each spoke 4 are integrally formed together as a one-piece structure, and are arranged at a common location in a longitudinal direction so that each of the spokes 4 shows a linear configuration (as shown in FIG. 1).

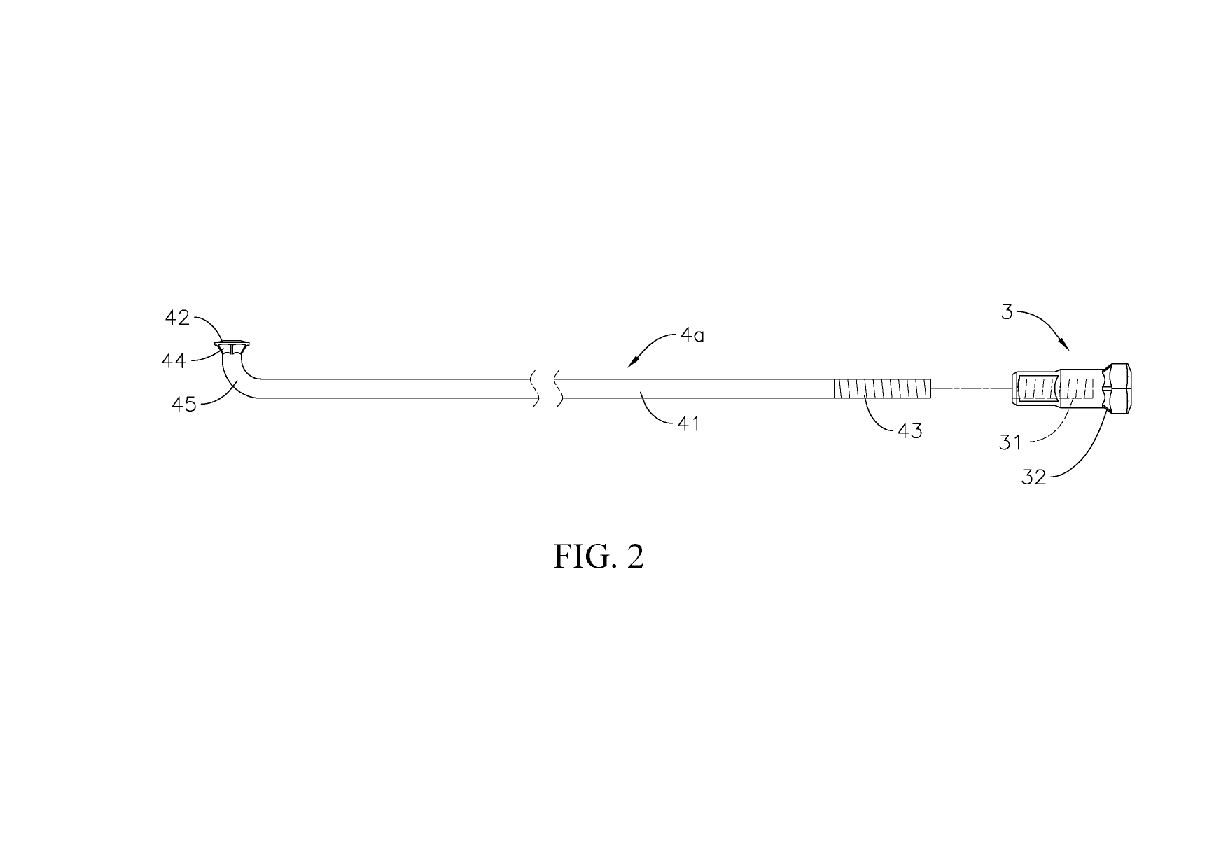

In one embodiment of the bicycle wheel assembly structure, each spoke 4a comprises a bend section 45 arranged between the intermediate section 41 and the head section 42, and the intermediate section 41, the head section 42, the thread section 43, and the bend section 45 are integrally formed together as a one-piece structure, and the intermediate section 41 and the thread section 43 are arranged at a common location in a longitudinal direction, while the head section 42 and the bend section 45 are arranged at a common location in a transverse direction, so that each spoke 4a shows a curved configuration on one end (as shown in FIG. 2).

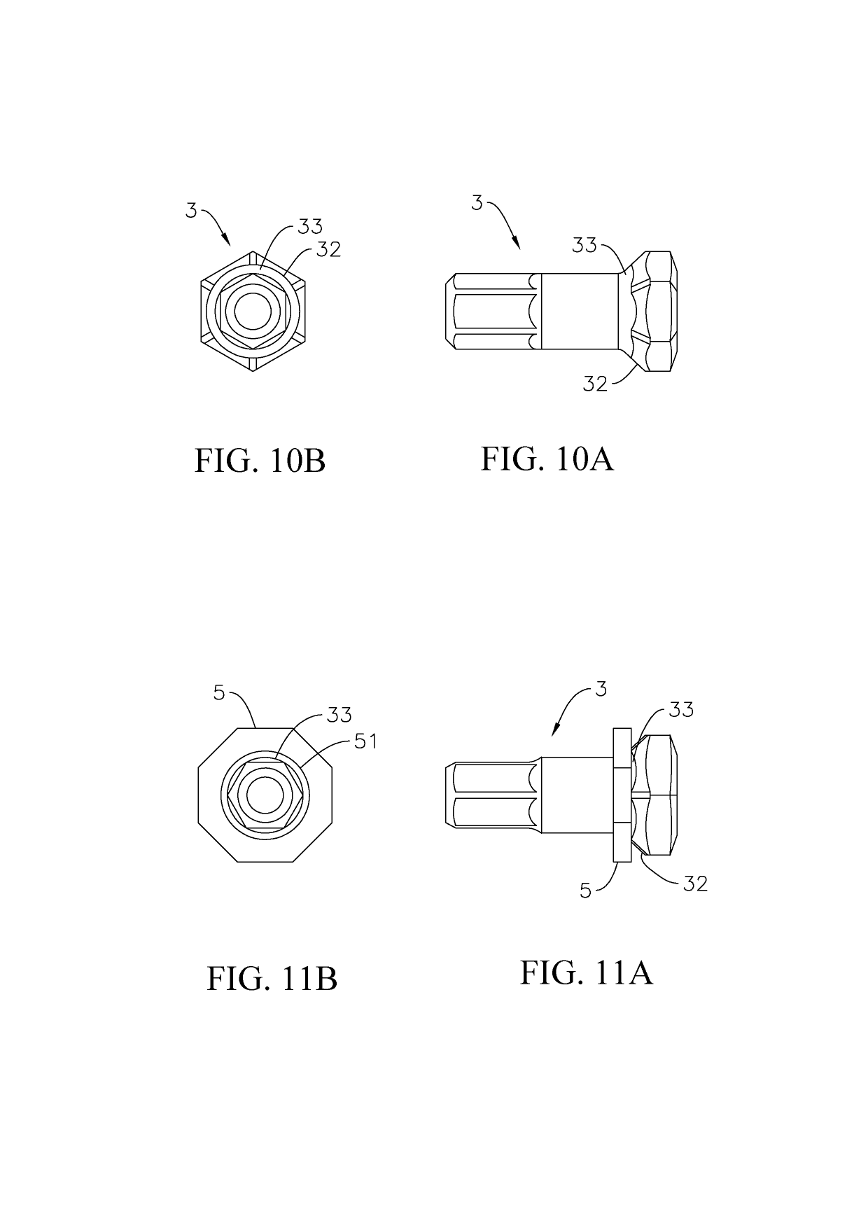

In one embodiment of the bicycle wheel assembly structure, the nipple 3 comprises a positioning portion 33 formed on one side of the nipple limiting part 32. A washer 5 is formed with an opening 51, and the opening 51 is fit to and matches the positioning portion 33, so that the washer 5 is set, in a removable manner, on the positioning portion 33(as shown in FIGS. 10A-11B).

As such, an effect of resisting loosening can be achieved indirectly on each of the nipples 3 by the positioning portion 33 through the washer 5. The positioning portion 33 allows a contact pressing force to convert from point contact into surface contact in order to effectively distribute stress concentration, this being particularly effective in protecting the rim from cracking or breaking.

Further, through the arrangement of the washer 5 in combination with the positioning portion 33, as a force applied to an outer end of the nipple 3 can be effectively spread and dispersed between the positioning portion 33 and the washer 5, the occurrence of compression and shear failure can be reduced, thereby reducing the probability of breaking of the nipple 3.

Further, referring to FIGS. 5A and 5B, 7A and 7B, and 9A and 9B, the convex hexagonal pyramid of the nipple limiting part 32 can alternatively be replaced with a cone, where the apex angle of the cone can similarly be one of 60°, 90°, and 120°, and this is selected and set according to elongation of the material of the respective spoke 4.

The above describes the various components of the present invention and the assembly thereof. In the following, the features and effects of the use of the present invention will be explained.

Firstly, for the contact surface between the nipple 3 and the annular rim 1, the apex angle or conic angle must be compatible with or match the elongation of the spoke 4.

Further, for the contact surface between the nipple 3 and the annular rim 1, the smaller the apex angle or conic angle, the better it prevents loosening, but rotation resistance and bouncing of the nipple 3 will become more pronounced in assembling.

During the course when the tension of the spoke 4 is continuously increasing, the risk of breakage is also increasing. For example, a spoke 4 made of a carbon fiber material has high strength but extremely low ductility. When assembled using a nipple 3 of a small 60° angle, for each turn of rotation, the nipple 3 bounces and stretches the spoke 4 six times. Under this condition, the bonding component of a spoke 4 made of a carbon fiber material, or an annular rim 1 made of a carbon fiber material may be damaged and thus broken. Therefore, to avoid such a condition, a nipple 3 with a large 120° angle can be used to reduce the resistance and the amplitude of bounce.

Further, the nipple 3 shown in FIGS. 4A and 4B is made of a material selected from copper materials, and the apex angle of the convex hexagonal pyramid of the nipple limiting part 32 is 60°, suitable for use with a spoke made of a material of high elongation. The spoke can be for example a beta titanium spoke or spokes of various memory metals. The nipple 3a shown in FIG. 5A is made of a material selected from aluminum materials.

Further, the nipple 3 shown in FIGS. 6A and 6B is made of a material selected from copper materials, and the apex angle of the convex hexagonal pyramid of the nipple limiting part 32 is 90°, suitable for use with a spoke made of a material of medium elongation. The spoke can be for example a SUS304 spoke or a medium carbon steel spoke. The nipple 3b shown in FIG. 7A is made of a material selected from aluminum materials.

Further, the nipple 3 shown in FIGS. 8A and 8B is made of a material selected from copper materials, and the apex angle of the convex hexagonal pyramid of the nipple limiting part 32 is 120°, suitable for use with a spoke made of a material of low elongation. The spoke can be for example a carbon fiber spoke or a high carbon steel spoke. The nipple 3c shown in FIG. 9A is made of a material selected from aluminum materials.

As such, the angle of the convex hexagonal pyramid of each of the nipple limiting part 32 is one of 60°, 90°, and 120°, and is selected and set according to elongation of the material of each of the spokes 4. The beneficial effects generated by such an arrangement include at least the following:

(1) Avoid stress concentration, reduce crack paths, and decrease crack damage.

(2) Achieve optimum locking based on the material of the spokes.

(3) Extend the service life.

In the present invention, the rim-side limiting part 12 and the nipple limiting part 32, and also, the hub-side limiting part 22 and the spoke limiting part 44, are each of a hexagonal pyramid configuration of which the apex is truncated to show a planar surface, and including bevel facets, in order to form interference fitting therebetween and to provide, simultaneously, a sliding preventing effect induced by geometric position constraining and high static friction at the two ends respectively associated with the annular rim 1 and the hub 2.

In the present invention, the angle of the convex hexagonal pyramid of the nipple limiting part 32 is one of 60°, 90°, and 120°, and is set in an optimum manner according to material elongation of each of the spokes 4 and the desired tension, so as to avoid stress concentration and to extend the service life.

This significantly improves the anti-loosening performance of the bicycle wheel assembly, increases shock resistance and stability, and enhances maintenance convenience, and also offers at least the following benefits:

(1) A long-term anti-loosening effect is provided, effectively addressing the inherent deficiency of the prior art that is prone to loosening.

(2) The optimal angle can be selected based on the material properties of the spokes, preventing the service life from becoming excessively short.

(3) Convenient maintenance and timely adjustment are possible, without sacrificing future maintenance convenience.

(4) Modular and customizable options are possible, allowing for adjustment of angle combinations to suit uses of various types of bicycles (for use in road racing, mountain biking, in-ground racing, and general disc brakes).

I claim:

1. A bicycle wheel assembly structure, comprising:
an annular rim, which comprises multiple rim penetration sections, each of the rim penetration sections being provided, on a circumference thereof, with a rim-side limiting part;
a hub, which is arranged at a center of the annular rim, the hub comprising multiple hub penetration sections;
multiple nipples, each of the nipples being provided, in inside thereof, with a thread-connecting section, each of the nipples being provided, on outside thereof, with a nipple limiting part, the nipples being respectively arranged on the rim penetration sections of the annular rim, the nipple limiting part of each of the nipples being mounted to a respective one of the rim-side limiting parts; and
multiple spokes, each of which comprises an intermediate section, a head section, and a thread section, the head section being arranged at one end of the intermediate section, the thread section being arranged at an opposite end of the intermediate section, the head sections of the spokes being respectively mounted to the hub penetration sections, the thread sections of the spokes being respectively connected to the thread-connecting sections of the nipples;
wherein each of the rim-side limiting parts is in the form of a concave hexagonal pyramid cavity with apex truncated to form a planar surface, and each of the rim-side limiting parts has an inside surface in the form of a polygonal surface with bevel facets; each of the nipple limiting parts is in the form of a convex hexagonal pyramid with apex truncated to form a planar surface, and including bevel facets, wherein each of the nipple limiting parts is combinable with a respective one of the rim-side limiting parts to constrain each other in position;
wherein each of the hub penetration sections is provided, on an inside circumference, with a hub-side limiting part, and each of the spokes is provided, on an outside circumference of the head section, with a spoke limiting part, the head sections of the spokes being respectively mounted to the hub penetration sections through the spoke limiting parts;
wherein each of the hub-side limiting parts is in the form of a concave hexagonal pyramid cavity with apex truncated to form a planar surface, and each of the hub-side limiting parts has an inside surface in the form of a polygonal surface including bevel facets; each of the spoke limiting parts is in the form of a convex hexagonal pyramid with apex truncated to form a planar surface, and including bevel facets, wherein each of the spoke limiting parts is combinable with a respective one of the hub-side limiting parts to constrain each other in position;
wherein the thread sections of the spokes are respectively connected to the thread-connecting sections of the nipples, and are screwed tightly to induce a tension, which drives each of the nipple limiting parts to penetrate into a respective one of the rim-side limiting parts, making contact with and abutting against the polygonal surface to form interference fitting so as to generate a high static frictional force, and
simultaneously, the spoke limiting part on the opposite end of each of the spokes penetrates into the respective one of the hub-side limiting parts, and generate geometric constraint through contact with the polygonal surface, so that an effect of geometric friction-induced sliding prevention and positioning is simultaneously generated on two opposite ends respectively mounted to the annular rim and the hub to thereby avoid loosening or rotational shifting caused by vibration; and
wherein the convex hexagonal pyramid of each of the nipple limiting parts has an apex angle that is one of 60°, 90°, and 120°, and is selected and set according to elongation of material of a respective one of the spokes.

2. The bicycle wheel assembly structure according to claim 1, wherein the apex angle of the convex hexagonal pyramid of the nipple limiting part is 60° for use with a material of high elongation.

3. The bicycle wheel assembly structure according to claim 1, wherein the apex angle of the convex hexagonal pyramid of the nipple limiting part is 90°for use with a material of medium elongation.

4. The bicycle wheel assembly structure according to claim 1, wherein the apex angle of the convex hexagonal pyramid of the nipple limiting part is 120°for use with a material of low elongation.

5. The bicycle wheel assembly structure according to claim 1, wherein contact surfaces of the rim-side limiting part and the nipple limiting part include a rough patter or a minute toothed pattern to increase the static frictional force.

6. The bicycle wheel assembly structure according to claim 1, wherein the intermediate section, the head section, and the thread section of each of the spokes are integrally formed together as a one-piece structure, and are arranged at a common location in a longitudinal direction so that the spoke shows a linear configuration.

7. The bicycle wheel assembly structure according to claim 1, wherein each of the spokes comprises a bend section arranged between the intermediate section and the head section, and the intermediate section, the head section, the thread section, and the bend section are integrally formed together as a one-piece structure, and the intermediate section and the thread section are arranged at a common location in a longitudinal direction, while the head section and the bend section are arranged at a common location in a transverse direction, so that the spoke shows a curved configuration on one end.

8. The bicycle wheel assembly structure according to claim 1, wherein each of the nipples comprises a positioning portion formed on one side of the nipple limiting part, and a washer is formed with an opening, wherein the opening is fit to the positioning portion, so that the washer is set on the positioning portion in a removable manner.
